(19) United States
(12) Patent Application Publication
(10) Pub. No.: US 2026/0258576 A1
(43) Pub. Date: Sep. 3, 2026

(54) METHOD FOR MANAGING ELECTRODEPOSITION LIQUID, AND ELECTRODEPOSITION DEVICE

(71) Applicant: MITSUBISHI MATERIALS CORPORATION, Tokyo (JP)

(72) Inventors: Kenji Kubota, Naka-shi (JP); Kei Fukushima, Naka-shi (JP); Fuyumi Mawatari, Naka-shi (JP); Takuma Nakagawa, Sanda-shi (JP); Yusuke Amata, Sanda-shi (JP); Masato Fujita, Sanda-shi (JP)

(73) Assignee: MITSUBISHI MATERIALS CORPORATION, Tokyo (JP)

(21) Appl. No.: 19/162,973

(22) PCT Filed: Apr. 3, 2024
(86) PCT No.: PCT/JP2024/013841

§ 371 Date: Sep. 8, 2025

(30) Foreign Application Priority Data
Apr. 24, 2023 (JP) 2023-070848
Feb. 7, 2024 (JP) 2024-017168

(51) Int. Cl. C25D 21/22

(52) U.S. Cl. CPC C25D 21/22

(57) ABSTRACT

A method for managing an electrodeposition dispersion is used in a case where an electrodeposition film is formed on a substrate having conductive properties by anionic electrodeposition, and the method includes: adjusting a concentration of an organic acid contained in the electrodeposition dispersion by subjecting the electrodeposition dispersion to an anion exchange treatment. An electrodeposition device is used in a case where an electrodeposition film is formed on a substrate having conductive properties by anionic electrodeposition, and the electrodeposition device includes: an electrodeposition tank in which an electrodeposition dispersion is stored and a substrate and a counter-electrode are immersed; an anion exchange means for subjecting the electrodeposition dispersion to an anion exchange treatment; and an electrodeposition dispersion circulation means for circulating the electrodeposition dispersion between the electrodeposition tank and the anion exchange means.

### TECHNICAL FIELD

The present invention relates to a method for managing an electrodeposition dispersion used in a case of electrodepositing an electrodeposition film onto a substrate having conductive properties by anionic electrodeposition, and an electrodeposition device.

The present application claims priority on Japanese Patent Application No. 2023-070848 filed on Apr. 24, 2023 and Japanese Patent Application No. 2024-017168 filed on Feb. 7, 2024, the contents of which are incorporated herein by reference.

### BACKGROUND ART

An insulated conductor in which a substrate having conductive properties is coated with an insulating film consisting of an insulating resin is widely used as a conductive material or a heat dissipation plate material for various types of electrical devices that require insulation.

Various resins are used as constituent materials of the insulating film, and, for example, Patent Document 1 discloses the use of a polyimide resin such as a polyamide-imide resin, and Patent Document 2 proposes the use of a mixed resin of a polyimide resin and a fluorine resin.

As a method of forming the insulating film consisting of such an insulating resin on a surface of the substrate having conductive properties, an electrodeposition method is known.

In the electrodeposition method, the substrate onto which the insulating film is to be formed and a counter-electrode are immersed in the electrodeposition dispersion in which materials of the insulating film are dispersed, and a voltage is applied between the substrate and the counter-electrode to deposit the materials of the insulating film onto the surface of the substrate; and thereby, the electrodeposition film is formed. Then, the formed electrodeposition film is heated to bake the electrodeposition film onto the substrate; and thereby, the insulating film is formed.

In addition, examples of the electrodeposition method include an anionic electrodeposition method of applying a voltage to the substrate as an anode to form the insulating film on the surface of the substrate, and a cationic electrodeposition method of applying a voltage to the substrate as a cathode to form the insulating film on the surface of the substrate.

### CITATION LIST

### Patent Documents

Patent Document 1: Japanese Unexamined Patent Application, First Publication No. 2017-115120
Patent Document 2: Japanese Unexamined Patent Application, First Publication No. 2018-070663

### SUMMARY OF INVENTION

### Technical Problem

An anionic electrodeposition dispersion used in the anionic electrodeposition method contains a solid component containing the above-described resin, water, an organic solvent, and a neutralizing agent, and the pH is decreased in the vicinity of the surface of the anode (substrate) by the application of a voltage, the solid component is deposited on the surface of the anode (substrate), and the electrodeposition film is formed.

In a case where the electrodeposition is continuously carried out by the anionic electrodeposition method, there is a concern that blistering may occur in a case where the electrodeposition film formed on the surface of the anode is baked to form the insulating film.

The present invention has been made in view of the above-described circumstances, and an object of the present invention is to provide a method for managing an electrodeposition dispersion and an electrodeposition device, with which the occurrence of the blistering can be suppressed in a case where an electrodeposition film is baked, and an insulating film can be stably formed.

### Solution to Problem

As a result of intensive studies conducted by the present inventors to achieve the above-described object, it has been found that, in a case where the electrodeposition is continuously carried out by the anionic electrodeposition method, a concentration of the organic acid contained in the electrodeposition dispersion increases, and the blistering occurs in a case where the electrodeposition film is baked.

Therefore, it has been found that the occurrence of the blistering during the baking can be suppressed by appropriately controlling the concentration of the organic acid contained in the electrodeposition dispersion.

The present invention has been made based on the above-described findings, and an aspect 1 of the present invention is a method for managing an electrodeposition dispersion that is used in a case where an electrodeposition film is formed on a substrate having conductive properties by anionic electrodeposition, the method includes: adjusting a concentration of an organic acid contained in the electrodeposition dispersion by subjecting the electrodeposition dispersion to an anion exchange treatment.

In the method for managing an electrodeposition dispersion according to the aspect 1 of the present invention, since the concentration of the organic acid contained in the electrodeposition dispersion is controlled, even in a case where the electrodeposition is continuously carried out, the concentration of the organic acid is not excessively increased, and it is possible to suppress the occurrence of the blistering during the baking and it is possible to stably form the insulating film.

An aspect 2 of the present invention is the method for managing an electrodeposition dispersion according to the aspect 1 of the present invention, in which the electrodeposition dispersion contains water, an organic solvent, a solid component, and a neutralizing agent, and the solid component includes at least a polyimide resin.

In the method for managing an electrodeposition dispersion according to the aspect 2 of the present invention, since the electrodeposition dispersion contains at least the polyimide resin as the solid component, it is possible to stably form the insulating film having excellent insulating properties.

An aspect 3 of the present invention is the method for managing an electrodeposition dispersion according to the aspect 1 or 2 of the present invention, in which the electrodeposition dispersion contains at least a carboxylic acid as the organic acid.

In the method for managing an electrodeposition dispersion according to the aspect 3 of the present invention, since the electrodeposition dispersion contains at least the carboxylic acid as the organic acid, it is possible to suppress a rapid decrease in pH on the surface of the anode (substrate) by the pH buffering effect of the carboxylic acid that is the organic acid, and it is possible to stably form the electrodeposition film.

An aspect 4 of the present invention is the method for managing an electrodeposition dispersion according to the aspect 1 or 2 of the present invention, in which the electrodeposition dispersion contains at least a hydroxy acid as the organic acid.

In the method for managing an electrodeposition dispersion according to the aspect 4 of the present invention, since the electrodeposition dispersion contains at least the hydroxy acid as the organic acid, it is possible to suppress a rapid decrease in pH on the surface of the anode (substrate) by the pH buffering effect of the hydroxy acid that is the organic acid, and it is possible to stably form the electrodeposition film.

An aspect 5 of the present invention is the method for managing an electrodeposition dispersion according to any one of the aspects 1 to 4 of the present invention, in which the concentration of the organic acid contained in the electrodeposition dispersion is adjusted to be in a range of 5 mg/L or more and 500 mg/L or less.

In the electrodeposition dispersion according to the aspect 5 of the present invention, since the concentration of the organic acid is adjusted to be in a range of 5 mg/L or more and 500 mg/L or less, it is possible to exert an appropriate pH buffering effect, and it is possible to stably form the electrodeposition film and it is possible to accurately suppress the occurrence of the blistering during the baking.

An aspect 6 of the present invention is the method for managing an electrodeposition dispersion according to any one of the aspects 1 to 5 of the present invention, in which the electrodeposition dispersion contains a fluororesin together with a polyimide resin as the solid component.

In the method for managing an electrodeposition dispersion according to the aspect 6 of the present invention, the fluororesin is contained together with the polyimide resin as the solid component, it is possible to form the insulating film having particularly excellent insulating properties and dielectric properties.

An aspect 7 of the present invention is an electrodeposition device that is used in a case where an electrodeposition film is formed on a substrate having conductive properties by anionic electrodeposition, the electrodeposition device includes: an electrodeposition tank in which an electrodeposition dispersion is stored and a substrate and a counter-electrode are immersed; an anion exchange means for subjecting the electrodeposition dispersion to an anion exchange treatment; and an electrodeposition dispersion circulation means for circulating the electrodeposition dispersion between the electrodeposition tank and the anion exchange means.

Since the electrodeposition device according to the aspect 7 of the present invention includes the electrodeposition tank, the anion exchange means for subjecting the electrodeposition dispersion to an anion exchange treatment, and the electrodeposition dispersion circulation means for circulating the electrodeposition dispersion between the electrodeposition tank and the anion exchange means, the concentration of the organic acid contained in the electrodeposition dispersion can be appropriately controlled, and, even in a case where the electrodeposition is continuously carried out, the concentration of the organic acid is not excessively increased, and the occurrence of the blistering during the baking can be suppressed, and the insulating film can be stably formed.

### Advantageous Effects of Invention

According to the present invention, it is possible to provide the method for managing an electrodeposition dispersion and the electrodeposition device, with which the occurrence of the blistering can be suppressed in a case where the electrodeposition film is baked, and the insulating film can be stably formed.

### BRIEF DESCRIPTION OF DRAWINGS

FIG. 1 A flowchart showing an insulating film production method using an electrodeposition device according to an embodiment of the present invention.

FIG. 2 A schematic explanatory diagram of the electrodeposition device according to the embodiment of the present invention.

FIG. 3 A schematic explanatory diagram of an electrodeposition device according to another embodiment of the present invention.

### DESCRIPTION OF EMBODIMENTS

Hereinafter, a method for managing an electrodeposition dispersion and an electrodeposition device according to an embodiment of the present invention, will be described.

The method for managing an electrodeposition dispersion according to the present embodiment is a method for managing an electrodeposition dispersion used in a case where an electrodeposition film serving as a precursor of an insulating film is formed on a surface of a substrate having conductive properties.

In the present embodiment, the method is for managing the electrodeposition dispersion used in an anionic electrodeposition method in which a voltage is applied to the substrate as an anode, and an insulating film is formed on the surface of the substrate that is the anode.

In the present embodiment, the electrodeposition dispersion to be managed contains water, an organic solvent, a solid component, and a neutralizing agent.

In the electrodeposition dispersion according to the present embodiment, as described above, since the electrodeposition dispersion is used in the anionic electrodeposition method, the electrodeposition dispersion contains an amine as the neutralizing agent.

Further, the electrodeposition dispersion according to the present embodiment may contain an organic acid in an appropriate amount in advance. By containing an appropriate amount of the organic acid in the electrodeposition film, it is possible to suppress the occurrence of the fine cracks in a baking step S03 described later.

At least a carboxylic acid may be contained as the organic acid. Examples of the carboxylic acid include formic acid, acetic acid, propionic acid, butyric acid, valeric acid, oxalic acid, malonic acid, benzoic acid, phthalic acid, trimellitic acid, hydroxy acid, and the like.

In particular, as the organic acid, at least a carboxylic acid is preferably contained. Examples of the hydroxy acid include glycolic acid, hydroxypropionic acid, hydroxybutyric acid, tartronic acid, glyceric acid, and the like. In addition, the hydroxypropionic acid, the hydroxybutyric acid, and the like exhibit effects thereof regardless of the position of the functional group, so that positional isomers also exhibit the effect.

In the present embodiment, the solid component includes at least a polyimide resin, and it is preferable that the solid component includes two types of resins, that is, a polyimide resin and a fluorine resin.

In the present embodiment, examples of the polyimide resin include polyamideimide, polyetherimide, polyimide, and the like. In addition, examples of the fluorine resin include polytetrafluoroethylene, perfluoroalkoxy alkane, and the like.

Further, an average particle diameter of the solid component need only be 50 nm or more and 300 nm or less, more preferably 50 nm or more and 250 nm or less, and still more preferably 50 nm or more and 200 nm or less. In addition, a standard deviation of the particle diameter of the solid component need only be 250 nm or less, more preferably 150 nm or less, and still more preferably 100 nm or less.

In the water and the organic solvent, the polyimide resin and the fluorine resin, which are the solid components, are dispersed.

Examples of the organic solvent include N,N-dimethylacetamide, propylene carbonate, dimethyl sulfoxide, N,N-dimethylformamide, y-butyrolactone, N-methyl-2-pyrrolidone, N-methyl-2-pyrrolidone, and the like.

In addition, a content ratio of the water in the electrodeposition dispersion is preferably 15% by mass or more and more preferably 50% by mass or more. In addition, the content ratio of water in the electrodeposition dispersion is preferably 85% by mass or less and more preferably 75% by mass or less.

Furthermore, a content ratio of the organic solvent in the electrodeposition dispersion is preferably 15% by mass or more and more preferably 50% by mass or more. In addition, the content ratio of the organic solvent in the electrodeposition dispersion is preferably 85% by mass or less and more preferably 75% by mass or less.

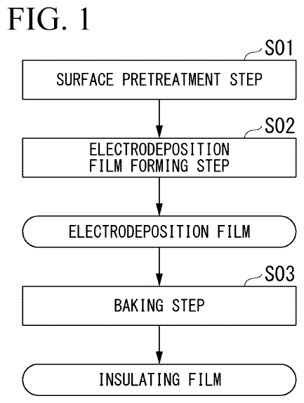

Next, the insulating film production method using the electrodeposition dispersion will be described with reference to FIG. 1.

As shown in FIG. 1, the insulating film production method in the present embodiment includes a surface pretreatment step S01, an electrodeposition film forming step S02, and a baking step S03.

### (Surface Pretreatment Step S01)

First, the substrate on which the electrodeposition film (insulating film) is to be formed is prepared. This substrate has conductive properties and is made of, for example, a metal material such as copper, a copper alloy, aluminum, or an aluminum alloy.

Then, the surface of the above-described substrate is treated with a surface treatment liquid such as an organic solvent or a surfactant to remove the adhering oil and fat or an oxidized film.

### (Electrodeposition Film Forming Step S02)

Next, the substrate and a counter-electrode are immersed in the electrodeposition dispersion according to the present embodiment, and a voltage is applied, with the substrate as the anode and the counter-electrode as the cathode, between the anode (substrate) and the cathode (counter-electrode). As a result, the pH of the electrodeposition dispersion in the vicinity of the substrate decreases, and the solid component (in the present embodiment, a mixture of the polyimide resin and the fluorine resin) is deposited on the surface of the substrate. As a result, the electrodeposition film is formed on the surface of the substrate. In this case, in the present embodiment, since the organic acid is added to the electrodeposition dispersion, the organic solvent is appropriately contained in the electrodeposition film due to the pH buffering effect of the organic acid.

A temperature (liquid temperature) of the electrodeposition dispersion in the electrodeposition film forming step S02 is preferably adjusted to be in a range of 5° C. or higher and 35° C. or lower.

By setting the liquid temperature to 5° C. or higher, it is possible to prevent water from being mixed into the electrodeposition dispersion due to condensation. On the other hand, by setting the liquid temperature to 35° C. or lower, the storage stability of the electrodeposition dispersion is improved, and the electrodeposition film can be stably formed.

The applied voltage between the substrate (anode) and the counter-electrode (cathode) in the electrodeposition film forming step S02 is preferably in a range of 10 V or more and 600 V or less.

By setting the applied voltage to 10 V or more, an electrodeposition rate can be ensured, and the productivity can be improved. On the other hand, by setting the applied voltage to 600 V or less, it is possible to suppress the generation of many bubbles on the surface of the substrate, and, in the baking step S03 which is the subsequent step, it is possible to suppress the occurrence of a large number of uneven structures in the insulating film due to the bubbles bursting.

### (Baking Step S03)

In the baking step S03, the substrate on which the electrodeposition film containing the solid component is formed in the electrodeposition film forming step S02 is dried, for example, in a temperature range of 200° C. or higher and equal to or lower than a melting point of the solid component, the residual electrodeposition dispersion is removed, and then the electrodeposition film is baked on the substrate to form the insulating film.

A baking temperature in the baking step S03 may be any temperature range in which the electrodeposition film of the solid component is formed and the insulating film is formed on the substrate, and need only be, for example, in a range of 200° C. or higher and 400° C. or lower. Further, the baking time need only be, for example, in a range of 0.5 minutes or more and 60 minutes or less.

Through the above-described steps, the insulating film containing the solid component is formed on the substrate having conductive properties.

In a case where the electrodeposition is continuously carried out, the organic acid such as the carboxylic acid is generated, and the concentration of the organic acid contained in the electrodeposition dispersion is increased. In this case, there is a concern that blistering may occur in a case where the electrodeposition film is baked.

Therefore, in the present embodiment, the electrodeposition dispersion is managed such that the concentration of the organic acid contained in the electrodeposition dispersion is controlled.

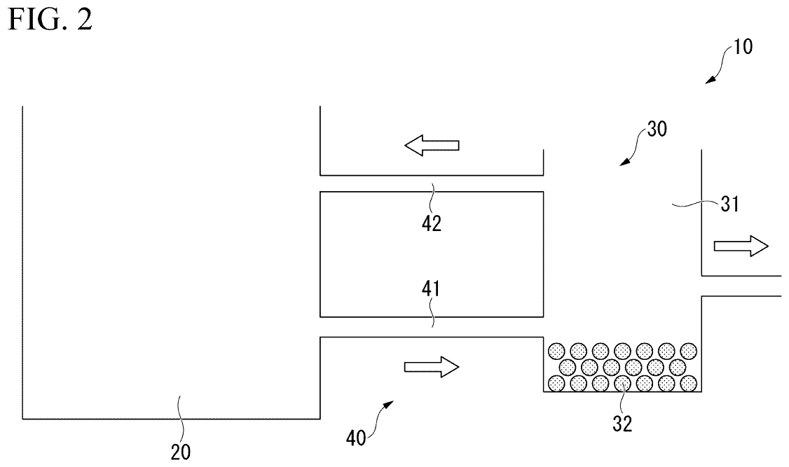

Hereinafter, the electrodeposition device 10 according to the present embodiment and the method for managing an electrodeposition dispersion using the electrodeposition device 30 will be described with reference to FIG. 2.

The electrodeposition device 10 shown in FIG. 2 includes an electrodeposition tank 20 in which the electrodeposition dispersion is stored and a substrate and a counter-electrode are immersed, an anion exchange means 30 for subjecting the electrodeposition dispersion to an anion exchange treatment, and an electrodeposition dispersion circulation means 40 (extraction pipe 41 and return pipe 42) for circulating the electrodeposition dispersion between the electrodeposition tank 20 and the anion exchange means 30.

The electrodeposition dispersion is stored in the electrodeposition tank 20, and the substrate serving as an anode and the counter-electrode serving as a cathode are immersed in the electrodeposition dispersion. Then, a voltage is applied between the substrate and the counter-electrode, to form the electrodeposition film on the surface of the substrate.

As shown in FIG. 2, the anion exchange means 30 includes an anion exchange tank 31 in which an anion exchange resin 32 is disposed.

The electrodeposition dispersion is supplied from the electrodeposition tank 20 to the anion exchange tank 31 through the extraction pipe 41. By storing the electrodeposition dispersion in the anion exchange tank 31, the organic acid contained in the electrodeposition dispersion is removed by the anion exchange resin 32.

As a result, it is possible to control the concentration of the organic acid contained in the electrodeposition dispersion. Examples of the organic acid contained in the electrodeposition dispersion include a carboxylic acid.

Then, the electrodeposition dispersion in which the concentration of the organic acid is controlled in the anion exchange tank 31 is supplied to the electrodeposition tank 20 through the return pipe 42.

In the electrodeposition dispersion stored in the electrodeposition tank 20, the concentration of the organic acid is preferably controlled in a range of 5 mg/L or more and 500 mg/L or less.

In the method for managing an electrodeposition dispersion according to the present embodiment having the above-described configuration, since the concentration of the organic acid contained in the electrodeposition dispersion is controlled, even in a case where the electrodeposition is continuously carried out, the concentration of the organic acid is not excessively increased, and it is possible to suppress the occurrence of the blistering during the baking and it is possible to stably form the insulating film.

In the present embodiment, in a case where the electrodeposition dispersion contains the water, the organic solvent, the solid component, and the neutralizing agent and the solid component includes at least the polyimide resin, the electrodeposition film containing at least the polyimide resin can be formed, and the insulating film having excellent insulating properties can be stably formed.

In the present embodiment, in a case where the electrodeposition dispersion contains at least the carboxylic acid as the organic acid, a rapid decrease in pH on the surface of the anode (substrate) can be suppressed by the pH buffering effect of the organic acid, and the electrodeposition film can be stably formed.

In the present embodiment, in a case where the electrodeposition dispersion contains at least the hydroxy acid as the organic acid, a rapid decrease in pH on the surface of the anode (substrate) can be suppressed by the pH buffering effect of the organic acid, and the electrodeposition film can be stably formed.

In the present embodiment, in a case where the concentration of the organic acid contained in the electrodeposition dispersion is adjusted to be in a range of 5 mg/L or more and 500 mg/L or less, it is possible to exert an appropriate pH buffering effect, and it is possible to stably form the electrodeposition film and it is possible to accurately suppress the occurrence of the blistering during the baking.

In the present embodiment, in a case where the electrodeposition dispersion contains, as the solid component, the fluororesin together with the polyimide resin, the electrodeposition film containing the mixed resin of the polyimide resin and the fluororesin can be formed, and the insulating film with particularly excellent insulating properties can be stably formed.

Since the electrodeposition device 10 according to the present embodiment includes the electrodeposition tank in which the electrodeposition dispersion is stored and the substrate and the counter-electrode are immersed, the anion exchange means for subjecting the electrodeposition dispersion to the anion exchange treatment, and the electrodeposition dispersion circulation means for circulating the electrodeposition dispersion between the electrodeposition tank and the anion exchange means, the concentration of the organic acid contained in the electrodeposition dispersion can be appropriately adjusted, and, even in a case where the electrodeposition is continuously carried out, the concentration of the organic acid is not excessively increased, and the occurrence of the blistering during the baking can be suppressed, and the insulating film can be stably formed.

The embodiment of the present invention has been described as above, but the present invention is not limited to such an embodiment, and can be changed as appropriate without departing from the technical features of the present invention.

In the present embodiment, the electrodeposition device shown in FIG. 2 has been described as an example, but the present invention is not limited to such an electrodeposition device, and an electrodeposition device having another configuration may be used.

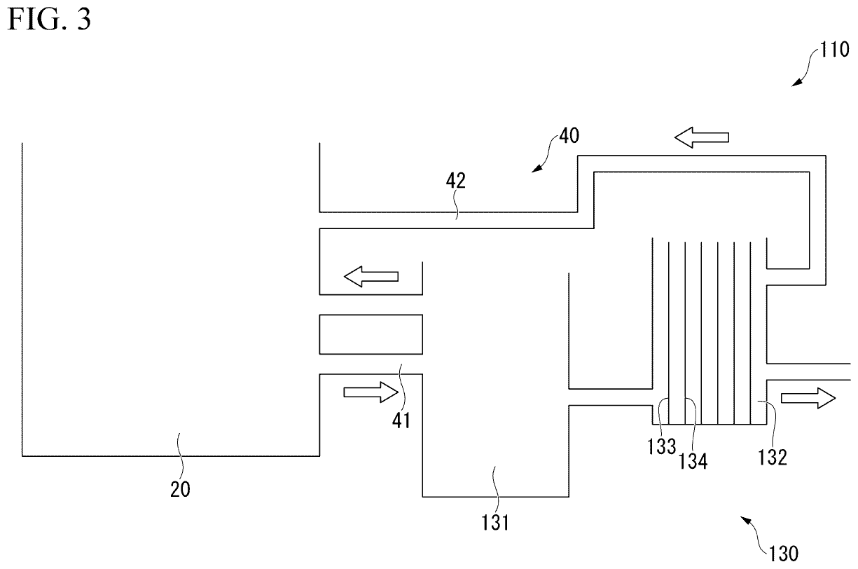

For example, an electrodeposition device 110 shown in FIG. 3 may be used. In the electrodeposition device 110 shown in FIG. 3, the anion exchange means 130 for subjecting the electrodeposition dispersion to the anion exchange treatment may include a ultrafiltration device 131 and an exchange film tank 132 in which an anion exchange film 133 and a cation exchange film 134 are alternately disposed. As another method for controlling the organic acid, a method using electrodialysis or the like may be applied.

### Examples

Hereinafter, the results of confirmation experiments performed to confirm the effectiveness of the present invention will be described.

As shown in Tables 1 and 2, the water, the organic solvent, the solid component, the neutralizing agent, and the organic acid were prepared, and these were mixed in (Mass ratio) shown in Tables 1 and 2; and thereby, the electrodeposition dispersion was obtained.

In Invention Examples 1 to 24, the electrodeposition dispersion was subjected to the anion exchange treatment using the electrodeposition device shown in FIG. 2. As a result, the change in the concentration of the organic acid is shown in Tables 1 and 2.

The concentration of the organic acid contained in the electrodeposition film was evaluated in the following manner.

The electrodeposition dispersion was diluted with ultrapure water, and then a filtrate obtained by removing impurities and passing through a membrane filter was used as a solution for ion chromatography measurement.

Next, the measurement was performed using an ion chromatograph Thermo Fisher Scientific ICS-5000+. Anion-exchange columns Dionex IonPac AG15 and Dionex IonPac AS15 were used as stationary phases of the ion chromatograph, an aqueous potassium hydroxide solution was used as an eluent, a Dionex ADRS 600 was used as a suppressor, and a detector for detecting electrical conductivity was used.

In addition, the stability of the electrodeposition dispersions of Invention Examples 1 to 24, on which the anion exchange treatment was performed, and the stability of the electrodeposition dispersions of Comparative Examples 1 to 3, on which the anion exchange treatment was not performed, were evaluated.

In a case where the electrodeposition dispersion was held at 40° C. for 5 days, a case where precipitation or separation occurred in the electrodeposition dispersion was evaluated as “B”, and a case where precipitation or separation did not occur in the electrodeposition dispersion was evaluated as “A”. The evaluation results are shown in Tables 1 and 2.

Then, a flat square rod (1.47 mm×2.94 mm x length of 25 cm) of oxygen-free copper was prepared as the substrate having conductive properties, and a cylindrical copper sheet was prepared as the counter-electrode.

The substrate and the counter-electrode were immersed in the above-described electrodeposition dispersion, and the liquid temperature of the electrodeposition dispersion was set to 20° C., the applied voltage was set to 300 V, and the holding time was set to 0.5 minutes; and thereby, the electrodeposition film was formed

Thereafter, the electrodeposition film was baked in a three-stage temperature rising profile of being held at a workpiece temperature of 140° C. to 170° C. during the backing for 10 minutes, at a workpiece temperature of 240° C. to 260° C. for 5 minutes, and at a workpiece temperature of 340° C. to 350° C. for 90 seconds, and then was rapidly cooled; and thereby, the insulating film was formed.

Then, the appearance of the formed insulating film was observed, and the blistering was evaluated.

A case where the blistering was observed in the insulating film by visual observation was evaluated as “present”, and a case where the blistering was not observed was evaluated as “absent”.

Further, the relative permittivity of the insulating film was measured in the following manner. The evaluation results are shown in Tables 1 and 2. Silver paste was applied to two 10 mm-wide portions at the ends and to a 100 mm-wide central portion on the surface of the insulating film; and thereby, a measurement sample was prepapred. The capacitance between the conductor and the silver paste in the central portion was measured using an IM3536 LCR meter manufactured by HIOKI E.E. CORPORATION, and the relative permittivity was calculated from the measured capacitance and the film thickness.

TABLE 1

| | | | | | Anion exchange | | | | |
|---|---|---|---|---|---|---|---|---|---|
| | | | | | Organic acid | | | | |
| | | | | | concentration | Organic acid | | | |
| | | | Solid | | before | concentration | Stability of | Evaluation | |
| | | Organic solvent | component | Organic acid | exchange | after exchange | electrodeposition | | Relative |
| | | Type | Type | Type | (mg/L) | (mg/L) | dispersion | Blistering | permittivity |
| Invention | 1 | N,N- | PAI | Methanesulfonic | 25 | 4 | A | Absent | 4.0 |
| Example | | dimethylacetamide | | acid | | | | | |
| | 2 | N,N- | PEI | Methanesulfonic | 30 | 3 | A | Absent | 3.6 |
| | | dimethylformamide | | acid | | | | | |
| | 3 | Propylene carbonate | PI | Trimellitic acid | 30 | 3 | A | Absent | 3.4 |
| | 4 | Dimethyl sulfoxide | PAI | Phthalic acid | 15 | 2 | A | Absent | 4.0 |
| | 5 | N,N- | PAI | Butyric acid | 20 | 3 | A | Absent | 4.0 |
| | | dimethylformamide | | | | | | | |
| | 6 | Propylene carbonate | PAI | Benzoic acid | 1000 | 300 | A | Absent | 4.0 |
| | 7 | γ-Butyrolactone | PAI | Formic acid | 1500 | 150 | A | Absent | 4.0 |
| | 8 | N,N- | PAI | Malonic acid | 1200 | 200 | A | Absent | 4.0 |
| | | dimethylacetamide | | | | | | | |
| | 9 | Propylene carbonate | PI | Benzoic acid | 1500 | 400 | A | Absent | 3.4 |
| | 10 | N-methyl-2- | PI | Formic acid + | 50 | 5 | A | Absent | 3.4 |
| | | pyrrolidone | | Trimellitic acid | | | | | |
| | 11 | N,N- | PI | Trimellitic acid | 100 | 50 | A | Absent | 3.4 |
| | | dimethylformamide | | | | | | | |
| | 12 | N,N- | PAI | Formic acid + | 500 | 150 | A | Absent | 4.0 |
| | | dimethylformamide | | Acetic acid | | | | | |
| | 13 | N-methyl-2- | PAI | Formic acid + | 1000 | 500 | A | Absent | 4.0 |
| | | pyrrolidone | | Phthalic acid + | | | | | |
| | | | | Butyric acid | | | | | |
| | 14 | N,N- | PAI | Formic acid + | 600 | 200 | A | Absent | 4.0 |
| | | dimethylacetamide | | Valeric acid | | | | | |

Polyimide resin: polyamideimide (PAI), polyimide (PI), and polyetherimide (PEI)
Fluorine resin: polytetrafluoroethylene (PTFE) and polytetrafluoroethylene-perfluoroalkyl vinyl ether (PFA)

TABLE 2

| | | | | | Anion exchange | | | | |
|---|---|---|---|---|---|---|---|---|---|
| | | | | | Organic acid | | | | |
| | | | | | concentration | Organic acid | Stability of | | |
| | | | Solid | | before | concentration | electro- | Evaluation | |
| | | Organic solvent | component | Organic acid | exchange | after exchange | deposition | | Relative |
| | | Type | Type | Type | (mg/L) | (mg/L) | dispersion | Blistering | permittivity |
| | 15 | Dimethyl sulfoxide | PAI | Formic acid + | 800 | 330 | A | Absent | 4.0 |
| | | | | Benzoic acid | | | | | |
| | 16 | N-methyl-2- | PAI | Formic acid + | 50 | 25 | A | Absent | 4.0 |
| | | pyrrolidone | | Malonic acid | | | | | |
| | 17 | Dimethyl sulfoxide | PAI | Formic acid + | 100 | 10 | A | Absent | 4.0 |
| | | | | Acetic acid + | | | | | |
| | | | | Butyric acid | | | | | |
| | 18 | N-methyl-2- | PAI + PFA | Formic acid | 80 | 40 | A | Absent | 2.6 |
| | | pyrrolidone | | | | | | | |
| | 19 | N-methyl-2- | PAI + PTFE | Formic acid | 100 | 60 | A | Absent | 2.7 |
| | | pyrrolidone | | | | | | | |
| | 20 | N-methyl-2- | PAI | Glycolic acid | 800 | 15 | A | Absent | 4.0 |
| | | pyrrolidone | | | | | | | |
| | 21 | N-methyl-2- | PAI | Hydroxypropionic | 600 | 30 | A | Absent | 4.0 |
| | | pyrrolidone | | acid | | | | | |
| | 22 | N-methyl-2- | PAI | Hydroxybutyric | 700 | 10 | A | Absent | 4.0 |
| | | pyrrolidone | | acid | | | | | |
| | 23 | N-methyl-2- | PAI | Tartronic acid | 650 | 200 | A | Absent | 4.0 |
| | | pyrrolidone | | | | | | | |
| | 24 | N-methyl-2- | PAI | Glyceric acid | 1200 | 250 | A | Absent | 4.0 |
| | | pyrrolidone | | | | | | | |
| Comparative | 1 | N,N- | PAI | Methanesulfonic | 600 | — | B | Present | 3.4 |
| Example | | dimethylacetamide | | acid | | | | | |
| | 2 | γ-Butyrolactone | PAI | Formic acid | 1500 | — | B | Present | 4.0 |
| | 3 | Propylene carbonate | PI | Benzoic acid | 1500 | — | B | Present | 2.7 |

Polyimide resin: polyamideimide (PAI), polyimide (PI), and polyetherimide (PEI)
Fluorine resin: polytetrafluoroethylene (PTFE) and polytetrafluoroethylene-perfluoroalkyl vinyl ether (PFA)

In Comparative Examples 1 to 3, since the concentration of the organic acid contained in the electrodeposition dispersion was not adjusted, the stability of the electrodeposition dispersion was evaluated as “B”. In addition, the blistering occurred in the insulating film after the baking.

On the other hand, in Invention Examples 1 to 24, since the concentration of the organic acid contained in the electrodeposition dispersion was adjusted, the stability of the electrodeposition dispersion was evaluated as “A”. In addition, the blistering did not occur in the insulating film after the baking.

Further, in Invention Examples 18 and 19, the solid component contained the polyimide resin and the fluororesin, and the relative permittivity was sufficiently low, and the insulating properties were particularly excellent.

From the results of the above-described confirmation experiments, it was confirmed that, according to Invention Examples, it was possible to provide the method for managing an electrodeposition dispersion and the electrodeposition device, with which the occurrence of the blistering could be suppressed in a case where the electrodeposition film was baked, and the insulating film could be stably formed.

### INDUSTRIAL APPLICABILITY

It is possible to provide the method for managing an electrodeposition dispersion and the electrodeposition device, with which the occurrence of the blistering can be suppressed in a case where the electrodeposition film is baked, and the insulating film can be stably formed.

1. A method for managing an electrodeposition dispersion that is used in a case where an electrodeposition film is formed on a substrate having conductive properties by anionic electrodeposition, the method comprising:
adjusting a concentration of an organic acid contained in the electrodeposition dispersion by subjecting the electrodeposition dispersion to an anion exchange treatment.

2. The method for managing an electrodeposition dispersion according to claim 1,
wherein the electrodeposition dispersion contains water, an organic solvent, a solid component, and a neutralizing agent, and the solid component includes at least a polyimide resin.

3. The method for managing an electrodeposition dispersion according to claim 1,
wherein the electrodeposition dispersion contains at least a carboxylic acid as the organic acid.

4. The method for managing an electrodeposition dispersion according to claim 1,
wherein the electrodeposition dispersion contains at least a hydroxy acid as the organic acid.

5. The method for managing an electrodeposition dispersion according to claim 1,
wherein the concentration of the organic acid contained in the electrodeposition dispersion is adjusted to be in a range of 5 mg/L or more and 500 mg/L or less.

6. The method for managing an electrodeposition dispersion according to claim 1,
wherein the electrodeposition dispersion contains a fluororesin together with a polyimide resin as the solid component.

7. An electrodeposition device that is used in a case where an electrodeposition film is formed on a substrate having conductive properties by anionic electrodeposition, the electrodeposition device comprising:
an electrodeposition tank in which an electrodeposition dispersion is stored and a substrate and a counter-electrode are immersed;
an anion exchange means for subjecting the electrodeposition dispersion to an anion exchange treatment; and
an electrodeposition dispersion circulation means for circulating the electrodeposition dispersion between the electrodeposition tank and the anion exchange means.
